(19) United States
(12) Patent Application Publication
(10) Pub. No.: US 2011/0182059 A1
(43) Pub. Date: Jul. 28, 2011

(54) Floatable diving torch

(76) Inventor: Yun-Zhao Liu, Zhongchan City (TW)

(21) Appl. No.: 12/656,289

(22) Filed: Jan. 25, 2010

(51) Int. Cl. F21L 4/00

(52) U.S. Cl. 362/158

(57) ABSTRACT

A diving torch that floats over the water is revealed. The diving torch includes a waterproof washer and a light transmitting lens, both locked and located on a front cover thereof. A front end of a barrel is enlarged outward to form a receiving space for loading a light cup and the receiving space is threaded with the front cover by a threaded portion. A waterproof washer is disposed around the threaded portion. Moreover, the bottom of the barrel is threaded and connected with a back cover by a threaded portion disposed with a waterproof washer. A switch set with a waterproof washer on the bottom is mounted in the back cover. Thereby not only people working on the water can pick up the diving torch quickly, people in the water and in distress can also use the diving torch asking for help.

### BACKGROUND OF THE INVENTION

1. Fields of the Invention

The present invention relates to a diving torch floating on the water, especially to a diving torch that floats on the water surface without sinking to the bottom while being dropped into the water. This people working on the water can pick up the diving torch quickly and conveniently once the diving torch fell into the water. Moreover, people in the water and in distress can use the torch asking for help. Thus the practical effects of the diving torch floating on the water are increased.

2. Descriptions of Related Art

A common electric torch available now consists of a main body, a light shade holder and a bottom cover. At least one light emitting part is mounted in a top of the main body and at least one battery provides power to the light emitting part. A switch member is for turning on or off the light emitting part. The battery is disposed in the main body and is limited by fastening of the bottom cover while the light shade holder is covered over the light emitting part and is threaded onto a top of the main body. Thereby an electric torch for lighting purposes is formed.

However, various kinds of electric torches available now can only provide lighting in use and have following shortcomings:

1. This type of electric torch has no waterproof design so that in use, circuitry and current-conducting strips inside the electric torch are easy to have rust stains due to moisture and dampness infiltrating into the electric torch so that the electric torch is damaged and out of order.
2. The electric torch is not only without waterproof design, but also unable to float. Thus once the electric torch is dropped into the water, it sinks to the bottom quickly. For people working on the water, the electric torch is often dropped into the water and sinking into the bottom. Thus the electric torch is lost or damaged and this causes a great loss.
3. The electric torch generally includes a switch for turning on/off the electric torch disposed on a lateral side of a main body. Or the on/off is controlled by adjusting the degree of thread tightness of the main body with the light shade holder/or the bottom cover. However, electric torches with such design are unable to resists water and withstand water pressure so that they can't be use in the water.

### SUMMARY OF THE INVENTION

Therefore it is a primary object of the present invention to provide a floatable diving torch that floats on the water surface without sinking to the bottom once the diving torch is dropped into the water. For people working on the water, they can pick up the diving torch quickly and conveniently while the diving torch falling into the water. Moreover, people in the water and in distress can use the diving torch asking for help. Thus the practical effects of the diving torch floating on the water are increased.

In order to achieve above object, floatable diving torch according to the present invention includes a waterproof washer and a light transmitting lens, both locked and located on a front cover thereof. A front end of a barrel is enlarged outward to form a receiving space for loading a light cup and part of the outer surface of the receiving space is threaded with the front cover by a threaded portion. A waterproof washer is disposed around the treaded portion. Moreover, the bottom of the barrel is threaded with a back cover by a threaded portion formed on an outer edge thereof. Mother waterproof washer is arranged around the threaded portion on the bottom of the barrel. A switch set is mounted in the back cover. A further waterproof washer inserted through a through hole of the back cover and connected with the through hole correspondingly is arranged at the bottom of the switch set.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is an explosive view of an embodiment according to the present invention;

FIG. 2 is a perspective view showing a torch assembly of an embodiment according to the present invention;

FIG. 3 is a cross sectional view of an embodiment in use according to the present invention;

FIG. 4 is a schematic drawing showing an embodiment used for help according to the present invention.

### DETAILED DESCRIPTION OF THE PREFERRED EMBODIMENT

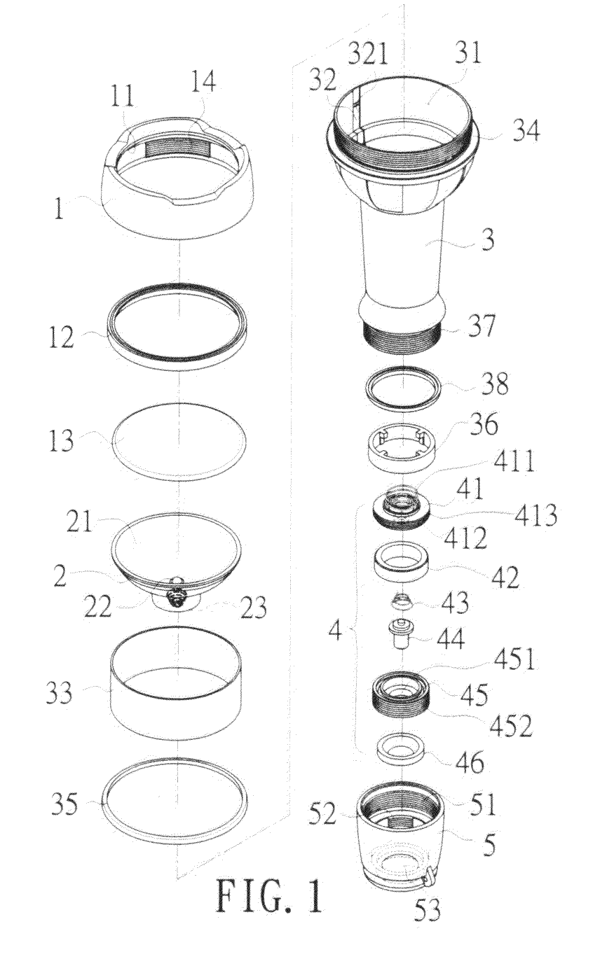

Refer to FIG. 1, the present invention mainly includes a front cover 1, a light cup 2, a barrel 3, a switch set 4 and a back cover 5.

The front cover 1 includes a leaning edge 11 formed in an inner edge of a front end thereof so as to mount and lock a waterproof washer 12 and a light transmitting lens 13. The waterproof washer 12 as well as the light transmitting lens 13 rests against the leaning edge 11. A threaded portion 14 is formed on an inner surface of the front cover 1.

An inner surface of the light cup 2 forms an optical mirror 21 and a light emitting part 22 is disposed on a center of the light cup 2. An electrical conductive element 23 corresponding to the light emitting part 22 is arranged at the bottom of the light cup 2.

A front end of the barrel 3 is enlarged outward to form a receiving space 31 and a slot 32 for mounting and locking an electrical conductive pad 321 is disposed on an inner surface between the receiving space 31 on the front end of the barrel 3 and a rear end of the barrel 3. An electrical conductive ring 33 is sleeved into and is locked inside the receiving space 31. The receiving space 31 is used to load the light cup 2 and a threaded portion 34 corresponding to the threaded portion 14 of the front cover 1 is formed on part of an outer surface of the receiving space 31. A waterproof washer 35 is disposed around an outer edge of a bottom end of the threaded portion 34. Moreover, an electrical conductive ring 36 is sleeved into a bottom end of the barrel 3. Similarly, a threaded portion 37 is formed on an outer surface of the bottom end of the barrel 3 and a waterproof washer 38 is arranged around an outer edge of a top end of the threaded portion 37.

The switch set 4 is arranged with a controller 41′. An electrical conductive element 411 is arranged on an outer surface of the controller 41 while a control switch 412 is disposed on an inner surface of the controller 41. Moreover, a threaded portion 413 is formed on an outer surface of the controller 41 and a locating ring 42 is arranged around a lower part of the controller 41. The switch set 4 further includes a return elastic element 43 and a press member 44 corresponding to the control switch 412 of the controller 41. When the press member 44 is pressed, the press member 44 just pushes the return elastic element 43 and further presses the control switch 412. Once there is no farce applied and the press member 44 is not pressed, the press member 44 turns back to original position by the return elastic element 43. The switch set 4 is further arranged with a press member locating sleeve 45 corresponding to the press member 44. The press member locating sleeve 45 includes a penetrating insertion hole 451 for the press member 44 to insert through and a threaded portion 452 formed on an outer surface of the press member locating sleeve 45 while a waterproof washer 46 is disposed on a bottom end of the press member locating sleeve 45 correspondingly.

A barrel's threaded portion 51 corresponding to the threaded portion 37 on the outer surface of the bottom end of the barrel 3 is disposed on an inner surface of an upper part of the back cover 5 and a switch set's threaded portion 52 corresponding to both the threaded portion 413 of the controller 41 of the switch set 4 and the threaded portion 452 of the press member locating sleeve 45 is arranged at an inner surface of a lower part of the back cover 5. Moreover, a bottom end of the back cover 5 is disposed with a through hole 53 corresponding to the waterproof washer 46 of the switch set 4.

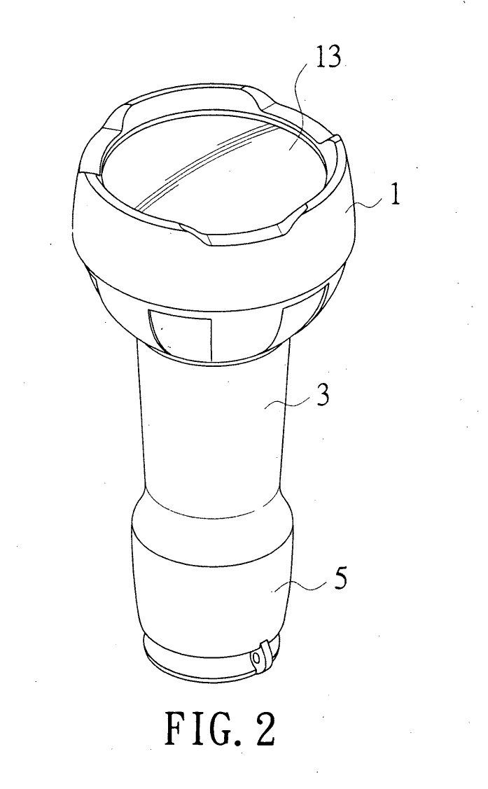

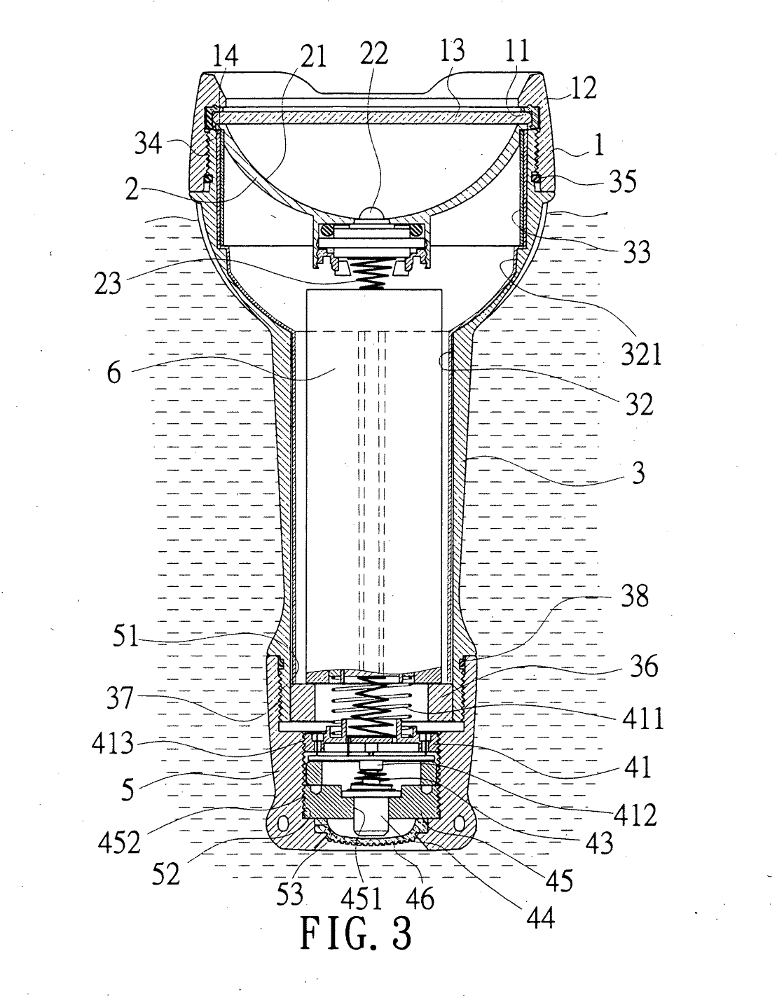

Refer to FIG. 2 and FIG. 3, the receiving space 31 on the front end of the barrel 3 is loaded with the light cup 2. The threaded portion 14 of the front cover 1 is threaded and connected with the threaded portion 34 on the outer surface of the receiving space 31. The edge on the top of the light cup 2 is leaning against the light transmitting lens 13 of the front cover 1. At least one battery 6 is mounted into an inner space of the barrel 3. The switch set 4 and the back cover 5 are connected with and located to each other by the threading and assembling of the threaded portions 413, 452 respectively of the controller 41 and of the press member locating sleeve 45 with the switch set's threaded portion 52. Then the barrel's threaded portion 51 on the inner surface of the upper part of the back cover 5 is threaded and connected with the threaded portion 37 on the outer surface of the bottom end of the barrel 3.

In use, the present invention prevents moisture ingress and provides waterproof protection by the waterproof washer 35 between the barrel 3 and the front cover 1, the water proof washer 38 between the barrel 3 and the back cover 5, and the waterproof washer 46 between the through hole 53 of the back cover 5 and the switch set 4. Once the diving torch is dropped into the water, it floats without sinking into the bottom due to the waterproof protection and air filled in the receiving space 31 on the front end of the barrel 3.

Furthermore, the switch set 4 is mounted in the back cover 5 and the waterproof washer 46 is disposed in the through hole of the back cover 5 correspondingly so that moisture will not enter through the through hole 53 of the back cover 5. Moreover, in the switch set 4, the control switch 412 of the controller 41 is pressed by the press member 44 and is protected by the press member locating sleeve 45 so that the controller 41 of the switch set 4 can withstand a high pressure.

In summary, the present invention has following advantages compared with the structure of the diving torch available now:

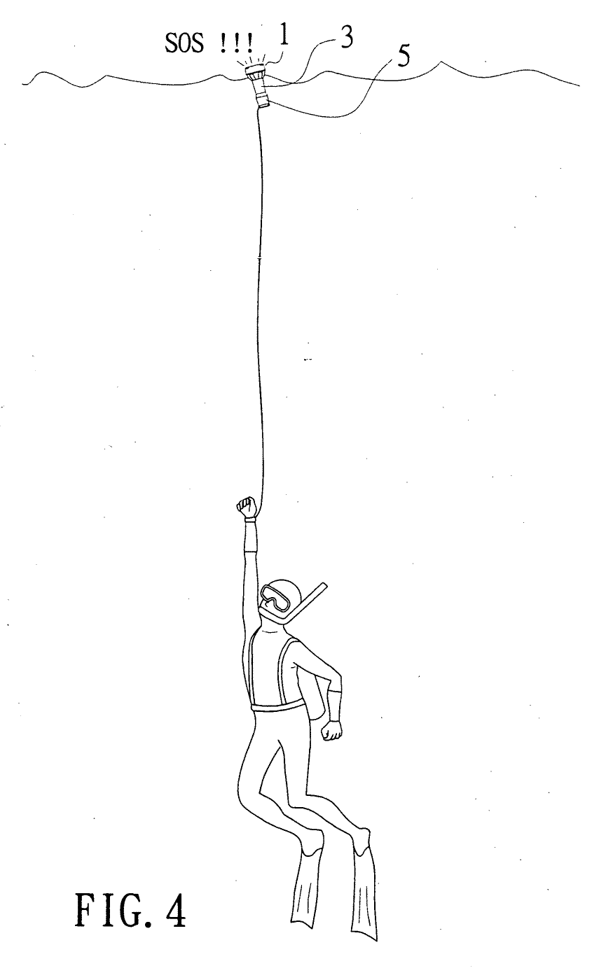

1. Due to waterproof washers respectively arranged between the barrel and the front cover, between the barrel and the back cover, and between the through hole of the back cover and the switch set, moisture will not enter the diving torch. Thus the diving torch is waterproof and is not easy to have rust stains or get damaged caused by moisture ingress.
2. The present invention prevents moisture ingress and provides waterproof protection by the waterproof washers arranged between the barrel and the front cover/the back cover, and between the through hole of the back cover and the switch set. Moreover, the front end of the barrel is extended outward to form a receiving space that is full of air. Thus the diving torch can still float over the water without sinking into the bottom once it is dropped into the water. Thus not only people working on the water can pick up the dropped diving torch quickly, people in the water and in distress can also use the diving torch asking for help.
3. The switch set of the present invention can withstand a high pressure and will not get damaged deep down under the sea. Thus divers can carry the diving torch with them while working under the water. Once they are in danger or trying to ask for help, the diving torch is blinking as a signal for help. By a rope connected the diving torch with the diver, the diving torch is released and is allowed to float on the water by the air in the receiving space of the barrel. Once the signal for help is received by people working over the water, they can rescue and help those in distress immediately and the rescue time is dramatically reduced, as shown in the schematic drawing of FIG. 4.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalents.

What is claimed is:

1. A floatable diving torch comprising a front cover, a light cup, a barrel, a switch set and a back cover; wherein
the front cover includes a leaning edge formed in an inner edge of a front end thereof, a waterproof washer and a light transmitting lens locked and located, and a threaded portion formed on an inner surface thereof;
the light cup having a light emitting part disposed on a center thereof, and an electrical conductive element corresponding to the light emitting part and arranged at the bottom thereof;
the barrel whose front end is enlarged outward to form a receiving space for loading a light cup, having a threaded portion corresponding to the threaded portion of the front cover and arranged at an outer surface of the receiving space, a waterproof washer disposed around an outer edge of a bottom end of the threaded portion, a further threaded portion formed on an outer surface of a bottom of the barrel, and a further waterproof washer arranged around an outer edge of a top end of the threaded portion;
the switch set with a waterproof washer arranged on a bottom end thereof; and
the back cover disposed with a barrel's threaded portion disposed on an inner surface of an upper part thereof and corresponding to the threaded portion on the outer surface of the bottom end, and having a through hole corresponding to the waterproof washer of the switch set; the switch set is mounted and fixed in the back cover.

2. The device as claimed in claim 1, wherein the switch set is arranged with a controller having an electrical conductive element arranged on an outer surface thereof, a control switch disposed on an inner surface thereof, and a threaded portion formed on an outer surface thereof; a locating ring is arranged around a lower part of the controller while the switch set further includes a return elastic element and a press member corresponding to the control switch of the controller, and a press member locating sleeve corresponding to the press member; the press member locating sleeve is disposed with a penetrating insertion hole for the press member to insert through and a threaded portion is formed on an outer surface of the press member locating sleeve while a waterproof washer is disposed on a bottom end of the press member locating sleeve correspondingly; an inner surface of a lower part of the back cover is disposed with a switch set's threaded portion corresponding to both the threaded portion of the controller of the switch set and the threaded portion of the press member locating sleeve.
